(19) United States
(12) Patent Application Publication
(10) Pub. No.: US 2024/0126579 A1
(43) Pub. Date: Apr. 18, 2024

(54) BARE METAL AS-IS SESSION

(71) Applicants: Akhilesh Thyagaturu, Tampa, FL (US); Jonathan L. Kyle, Atlanta, GA (US); Mohit Kumar Garg, Hisar (IN); Karthik Kumar, Chandler, AZ (US); Francesc Guim Bernat, Barcelona (ES)

(72) Inventors: Akhilesh Thyagaturu, Tampa, FL (US); Jonathan L. Kyle, Atlanta, GA (US); Mohit Kumar Garg, Hisar (IN); Karthik Kumar, Chandler, AZ (US); Francesc Guim Bernat, Barcelona (ES)

(21) Appl. No.: 18/397,256

(22) Filed: Dec. 27, 2023

(51) Int. Cl. G06F 9/455

(52) U.S. Cl. CPC G06F 9/45541; G06F 9/45558; G06F 2009/45595

(57) ABSTRACT

A server platform in a cloud computing system is determined to be in an unused state and a request from a remote computing system outside the data center system is received to control hardware of at least one of the server platforms of the cloud computing systems. A bare-metal-as-is (BMAI) session is initiated for the remote computing system to use the server platform based on the unused state, wherein exclusive control of at least a portion of hardware of the server platform is temporarily handed over to the remote computing system in the BMAI session. Control of the portion of the hardware of the server platform is reclaimed based on an end of the BMAI session.

### TECHNICAL FIELD

This disclosure relates in general to the field of computer networking, and more particularly, though not exclusively, to usage of cloud computing resources to supplement a non-cloud computing system.

### BACKGROUND

Edge computing, including mobile edge computing, may offer application developers and content providers cloud-computing capabilities and an information technology service environment at the edge of a network. Edge computing may have some advantages when compared to traditional centralized cloud computing environments. For example, edge computing may provide a service to a user equipment (UE) with a lower latency, a lower cost, a higher bandwidth, a closer proximity, or an exposure to real-time radio network and context information.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an overview of an Edge cloud configuration for edge computing.

FIG. 2 illustrates operational layers among endpoints, an edge cloud, and cloud computing environments.

FIG. 3 illustrates an example approach for networking and services in an edge computing system.

FIG. 4 illustrates a block diagram for an example edge computing device.

FIG. 5 illustrates an overview of layers of distributed compute deployed among an edge computing system.

FIG. 6 is a simplified block diagram illustrating example interactions between edge computing systems and an example cloud or data center system.

FIG. 7 is a simplified block diagram illustrating the example sharing of cloud or data center resources are shared with an edge computing system.

FIG. 8 is a simplified block diagram illustrating an example data center or cloud server system.

FIG. 9 is a representation of an example unused cloud resources table.

FIG. 10 is a simplified block diagram illustrating an example cloud system or data center system configured to support hardware-as-is sessions.

FIG. 11 is a simplified flow diagram illustrating an example technique for providing hardware-as-is sessions.

FIG. 12 illustrates a block diagram of components of an example computing platform.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

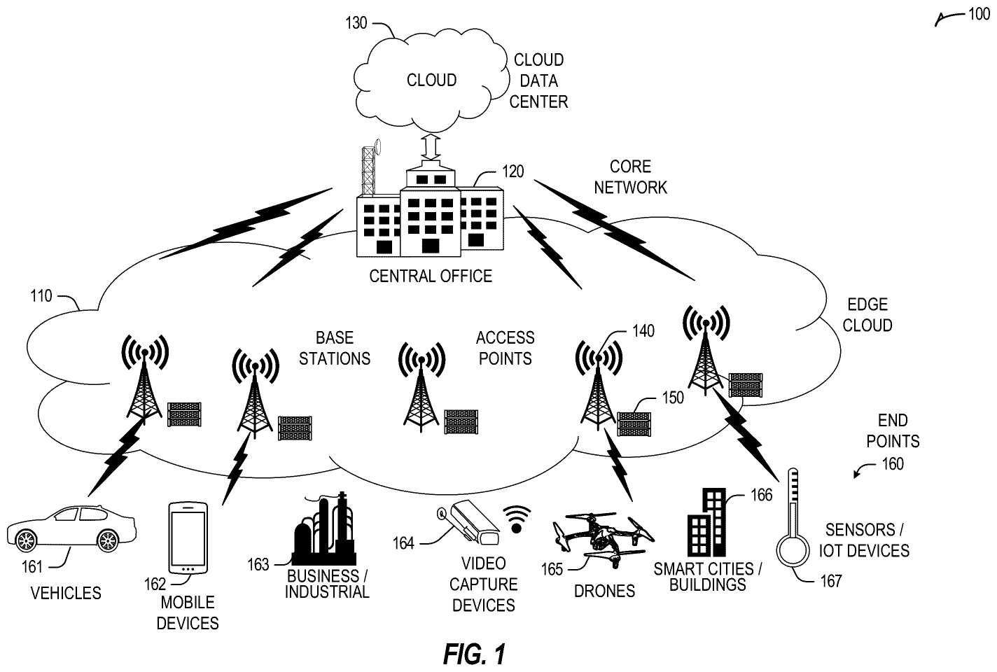

FIG. 1 is a block diagram 100 showing an overview of a configuration for edge computing, which includes a layer of processing referred to in many of the following examples as an “edge cloud” or “edge system”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 may be leveraged to provide ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

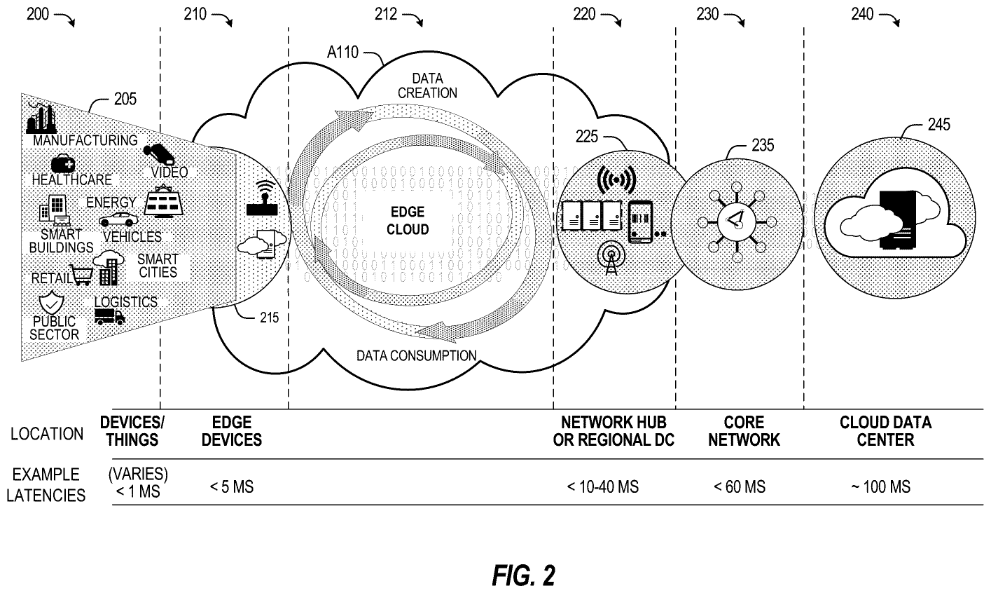

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following traditional caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues may be magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

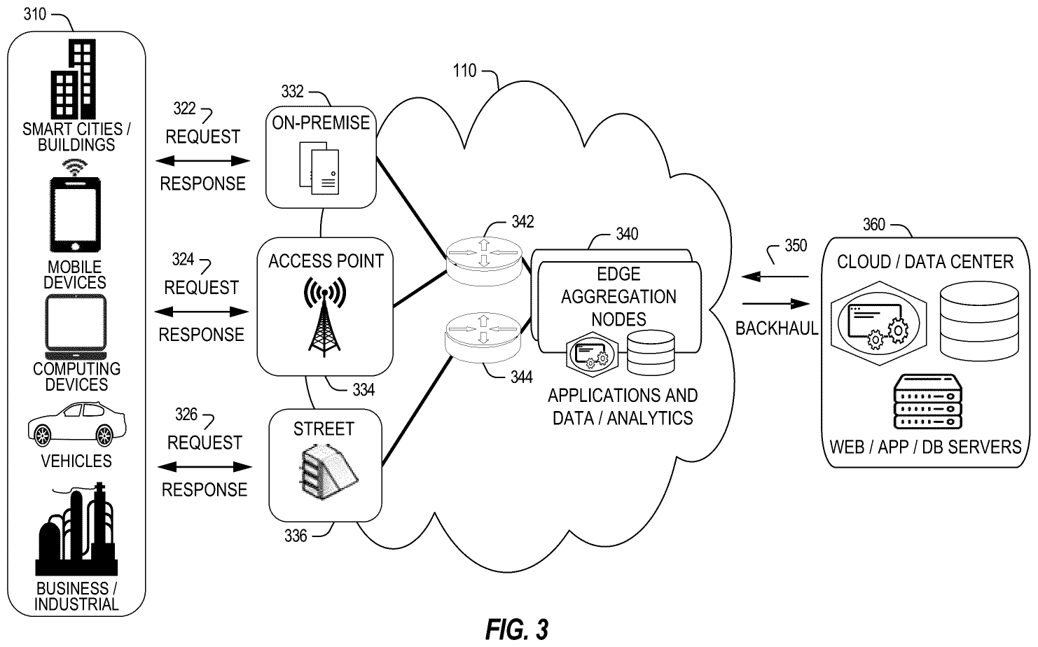

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

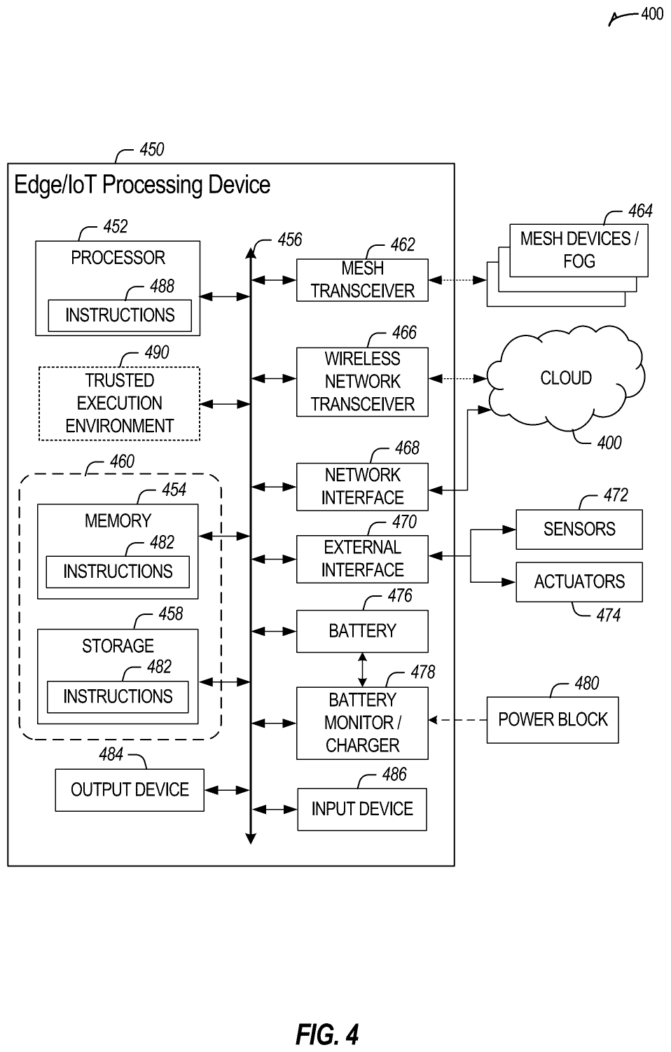

FIG. 4 is a block diagram of an example of components that may be present in an example edge computing device 450 for implementing the techniques described herein. The edge device 450 may include any combinations of the components shown in the example or referenced in the disclosure above. The components may be implemented as ICs, intellectual property blocks, portions thereof, discrete electronic devices, or other modules, logic, hardware, software, firmware, or a combination thereof adapted in the edge device 450, or as components otherwise incorporated within a chassis of a larger system. Additionally, the block diagram of FIG. 4 is intended to depict a high-level view of components of the edge device 450. However, some of the components shown may be omitted, additional components may be present, and different arrangement of the components shown may occur in other implementations.

The edge device 450 may include processor circuitry in the form of, for example, a processor 452, which may be a microprocessor, a multi-core processor, a multithreaded processor, an ultra-low voltage processor, an embedded processor, or other known processing elements. The processor 452 may be a part of a system on a chip (SoC) in which the processor 452 and other components are formed into a single integrated circuit, or a single package. The processor 452 may communicate with a system memory 454 over an interconnect 456 (e.g., a bus). Any number of memory devices may be used to provide for a given amount of system memory. To provide for persistent storage of information such as data, applications, operating systems and so forth, a storage 458 may also couple to the processor 452 via the interconnect 456. In an example the storage 458 may be implemented via a solid state disk drive (SSDD). Other devices that may be used for the storage 458 include flash memory cards, such as SD cards, microSD cards, xD picture cards, and the like, and USB flash drives. In low power implementations, the storage 458 may be on-die memory or registers associated with the processor 452. However, in some examples, the storage 458 may be implemented using a micro hard disk drive (HDD). Further, any number of new technologies may be used for the storage 458 in addition to, or instead of, the technologies described, such resistance change memories, phase change memories, holographic memories, or chemical memories, among others.

The components may communicate over the interconnect 456. The interconnect 456 may include any number of technologies, including industry standard architecture (ISA), extended ISA (EISA), peripheral component interconnect (PCI), peripheral component interconnect extended (PCIx), PCI express (PCIe), or any number of other technologies. The interconnect 456 may be a proprietary bus, for example, used in a SoC based system. Other bus systems may be included, such as an I2C interface, an SPI interface, point to point interfaces, and a power bus, among others.

Given the variety of types of applicable communications from the device to another component or network, applicable communications circuitry used by the device may include or be embodied by any one or more of components 462, 466, 468, or 470. Accordingly, in various examples, applicable means for communicating (e.g., receiving, transmitting, etc.) may be embodied by such communications circuitry. For instance, the interconnect 456 may couple the processor 452 to a mesh transceiver 462, for communications with other mesh devices 464. The mesh transceiver 462 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. The mesh transceiver 462 may communicate using multiple standards or radios for communications at different ranges.

A wireless network transceiver 466 may be included to communicate with devices or services in the cloud 400 via local or wide area network protocols. For instance, the edge device 450 may communicate over a wide area using LoRaWAN™ (Long Range Wide Area Network), among other example technologies. Indeed, any number of other radio communications and protocols may be used in addition to the systems mentioned for the mesh transceiver 462 and wireless network transceiver 466, as described herein. For example, the radio transceivers 462 and 466 may include an LTE or other cellular transceiver that uses spread spectrum (SPA/SAS) communications for implementing high speed communications. Further, any number of other protocols may be used, such as Wi-Fi® networks for medium speed communications and provision of network communications. A network interface controller (NIC) 468 may be included to provide a wired communication to the cloud 400 or to other devices, such as the mesh devices 464. The wired communication may provide an Ethernet connection, or may be based on other types of networks, protocols, and technologies

The interconnect 456 may couple the processor 452 to an external interface 470 that is used to connect external devices or subsystems. The external devices may include sensors 472, such as accelerometers, level sensors, flow sensors, optical light sensors, camera sensors, temperature sensors, a global positioning system (GPS) sensors, pressure sensors, barometric pressure sensors, and the like. The external interface 470 further may be used to connect the edge device 450 to actuators 474, such as power switches, valve actuators, an audible sound generator, a visual warning device, and the like.

In some optional examples, various input/output (I/O) devices may be present within, or connected to, the edge device 450. Further, some edge computing devices may be battery powered and include one or more batteries (e.g., 476) to power the device. In such instances, a battery monitor/charger 478 may be included in the edge device 450 to track the state of charge (SoCh) of the battery 476. The battery monitor/charger 478 may be used to monitor other parameters of the battery 476 to provide failure predictions, such as the state of health (SoH) and the state of function (SoF) of the battery 476, which may trigger an edge system to attempt to provision other hardware (e.g., in the edge cloud or a nearby cloud system) to supplement or replace a device whose power is failing, among other example uses. In some instances, the device 450 may also or instead include a power block 480, or other power supply coupled to a grid, may be coupled with the battery monitor/charger 478 to charge the battery 476. In some examples, the power block 480 may be replaced with a wireless power receiver to obtain the power wirelessly, for example, through a loop antenna in the edge device 450, among other examples.

The storage 458 may include instructions 482 in the form of software, firmware, or hardware commands to implement the workflows, services, microservices, or applications to be carried out in transactions of an edge system, including techniques described herein. Although such instructions 482 are shown as code blocks included in the memory 454 and the storage 458, it may be understood that any of the code blocks may be replaced with hardwired circuits, for example, built into an application specific integrated circuit (ASIC). In some implementations, hardware of the edge computing device 450 (separately, or in combination with the instructions 488) may configure execution or operation of a trusted execution environment (TEE) 490. In an example, the TEE 490 operates as a protected area accessible to the processor 452 for secure execution of instructions and secure access to data, among other example features.

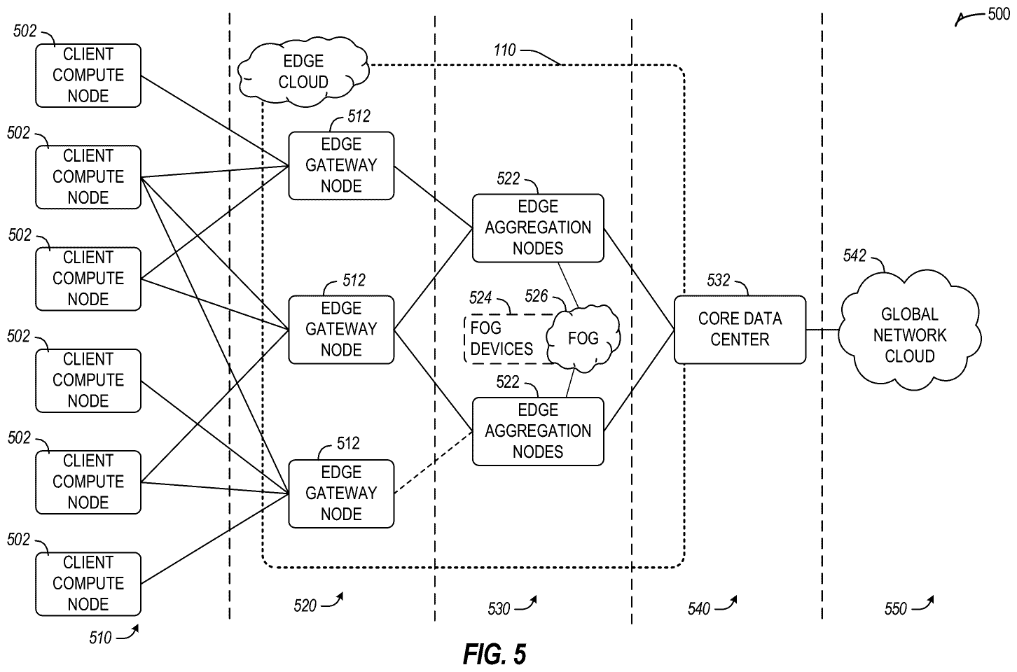

At a more generic level, an edge computing system may be described to encompass any number of deployments operating in an edge cloud 110, which provide coordination from client and distributed computing devices. FIG. 5 provides a further abstracted overview of layers of distributed compute deployed among an edge computing environment for purposes of illustration. For instance, FIG. 5 generically depicts an edge computing system for providing edge services and applications to multi-stakeholder entities, as distributed among one or more client compute nodes 502, one or more edge gateway nodes 512, one or more edge aggregation nodes 522, one or more core data centers 532, and a global network cloud 542, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

Each node or device of the edge computing system is located at a particular layer corresponding to layers 510, 520, 530, 540, 550. For example, the client compute nodes 502 are each located at an endpoint layer 510, while each of the edge gateway nodes 512 are located at an edge devices layer 520 (local level) of the edge computing system. Additionally, each of the edge aggregation nodes 522 (and/or fog devices 524, if arranged or operated with or among a fog networking configuration 526) are located at a network access layer 530 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 532 is located at a core network layer 540 (e.g., a regional or geographically-central level), while the global network cloud 542 is located at a cloud data center layer 550 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 532 may be located within, at, or near the edge cloud 110.

Although an illustrative number of client compute nodes 502, edge gateway nodes 512, edge aggregation nodes 522, core data centers 532, global network clouds 542 are shown in FIG. 5, it should be appreciated that the edge computing system may include more or fewer devices or systems at each layer. Additionally, as shown in FIG. 5, the number of components of each layer 510, 520, 530, 540, 550 generally increases at each lower level (i.e., when moving closer to endpoints). As such, one edge gateway node 512 may service multiple client compute nodes 502, and one edge aggregation node 522 may service multiple edge gateway nodes 512.

Consistent with the examples provided herein, each client compute node 502 may be embodied as any type of end point component, device, appliance, or “thing” capable of communicating as a producer or consumer of data. Further, the label “node” or “device” as used in the edge computing system 500. As such, the edge cloud 110 is formed from network components and functional features operated by and within the edge gateway nodes 512 and the edge aggregation nodes 522 of layers 520, 530, respectively. The edge cloud 110 may be embodied as any type of network that provides edge computing and/or storage resources which are proximately located to radio access network (RAN) capable endpoint devices (e.g., mobile computing devices, IoT devices, smart devices, etc.), which are shown in FIG. 5 as the client compute nodes 502. In other words, the edge cloud 110 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 110 may form a portion of or otherwise provide an ingress point into or across a fog networking configuration 526 (e.g., a network of fog devices 524, not shown in detail), which may be embodied as a system-level horizontal and distributed architecture that distributes resources and services to perform a specific function. For instance, a coordinated and distributed network of fog devices 524 may perform computing, storage, control, or networking aspects in the context of an IoT system arrangement. Other networked, aggregated, and distributed functions may exist in the edge cloud 110 between the cloud data center layer 550 and the client endpoints (e.g., client compute nodes 502).

The edge gateway nodes 512 and the edge aggregation nodes 522 cooperate to provide various edge services and security to the client compute nodes 502. Furthermore, because each client compute node 502 may be stationary or mobile, each edge gateway node 512 may cooperate with other edge gateway devices to propagate presently provided edge services and security as the corresponding client compute node 502 moves about a region. To do so, each of the edge gateway nodes 512 and/or edge aggregation nodes 522 may support multiple tenancy and multiple stakeholder configurations, in which services from (or hosted for) multiple service providers and multiple consumers may be supported and coordinated across a single or multiple compute devices.

A common issue limiting the performance and deployment of edge-based solutions are the constrained hardware resources in edge devices. In some implementations, edge devices may cooperate and coordinate with cloud-based resources as extensions to the cloud to derive the balance of hardware and computing resources to implement a particular solution. In some cases, cloud systems may have hardware which is temporarily unused by a corresponding cloud service provider (CSP). In order to better utilize their resources, it may be desirable to offer such unused resources for use by an edge device in an edge deployment to supplement the resources of the edge deployment. In other instances, unused cloud resources may be offered and used by client systems or even other cloud-based systems or data centers, among other examples. For instance, the unused resources may be leased or auctioned to offer a “bare metal as is” and realize an additional revenue stream, while better utilizing the resources of the cloud service provider or data center, among other example advantages.

Some providers have attempted to monetize underutilized data center hardware by offering Bare-Metal-as-a-Service (BMaaS) solutions. In a traditional BmaaS implementation, a CSP offers direct leasing of hardware from the CSP's resources (e.g., data center resources), but the CSP still maintains control and management of the hardware being leased. For instance, the CSP may provide a cloud orchestrator configured to manage the platform hardware being leased, limiting the degree to which the leased hardware may be controlled and managed by the customer (e.g., the customer may not access or manage the platform manager, etc.). While the customer may launch workloads that run directly on the physical hardware being leased within a BMaaS offering, ultimate control and management of the physical hardware remains limited by the CSP and its orchestrator. Some applications may benefit from workloads being run on on-premises physical hardware fully managed by the owner of the workload, for instance, by allowing the workload owner to have full access to configuring the physical network, power, I/O port configurations, etc., for instance, with dedicated external network capabilities. Such access and control is not available in traditional BMaaS offerings.

In an improved system, a bare metal as-is offering may be provided by a CSP to allow customers to have full access to unused CSP hardware resources as if the hardware were owned and managed on premises with other edge or client hardware of the customer. For instance, a customer may strategically request hardware from a CSP (e.g., based on the geo-location of the CSP hardware). For instance, management of an edge deployment may desire precise deployment and operational scenarios on-premises, including application and management (e.g., where a retail edge service manager wants to use the hardware at a specific geo location where they are opening a new store, among other examples).

In an example implementation of a bare metal as-is offering, a CSP or data center offering its hardware may limit its control of a particular block of hardware to providing power and networking functionality for the hardware block (e.g., a server node). The CSP or data center, however, may temporarily relinquish any management of the remaining hardware while it is leased out in a bare metal as-is offering. In the traditional, Bare-Metal-as-a-Service (BMaaS), Hardware/Platform-as-a-Service (HaaS/PaaS), the hardware resources are directly tracked and managed for service offering by the CSP. However, in a bare metal as-is offering, an orchestrator on the customer's system manages the leased cloud resources while isolated from the cloud orchestrator services, the CSP giving up hardware provisioning and management, including power management, to the customer. Accordingly, the client or edge device utilizes its orchestrator tool to manage hardware at the leased cloud location, including board management, control of local BIOS, power and network management, and management of other hardware resources made available on the leased cloud location. Such an offering allows the client or edge to enjoy on-premises manageability of the cloud hosted hardware, providing true isolation of these leased cloud hardware resources, making management of the leased cloud resources consistent with management of on-premises or local hardware of the edge or client system.

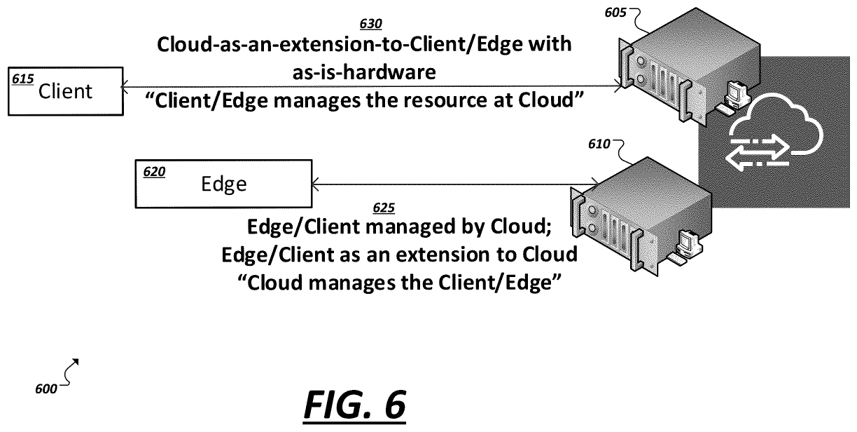

Turning to FIG. 6, a simplified block diagram 600 is shown illustrating edge and client systems' (e.g., 615, 620) interactions and coordination with an example cloud or data center system 650 to implement various applications, services, and solutions using both the edge/client hardware and hardware (e.g., 605, 610) of the cloud 650. As introduced above, in some instances, the cloud system 650 can effectively make use of and manage resources of the client/edge (e.g., at 625). In an improved solution, client/edge systems (e.g., 615, 620) can also now take temporary control of and leverage hardware (e.g., 605) of cloud systems (at 630) through a cloud hardware as-is service.

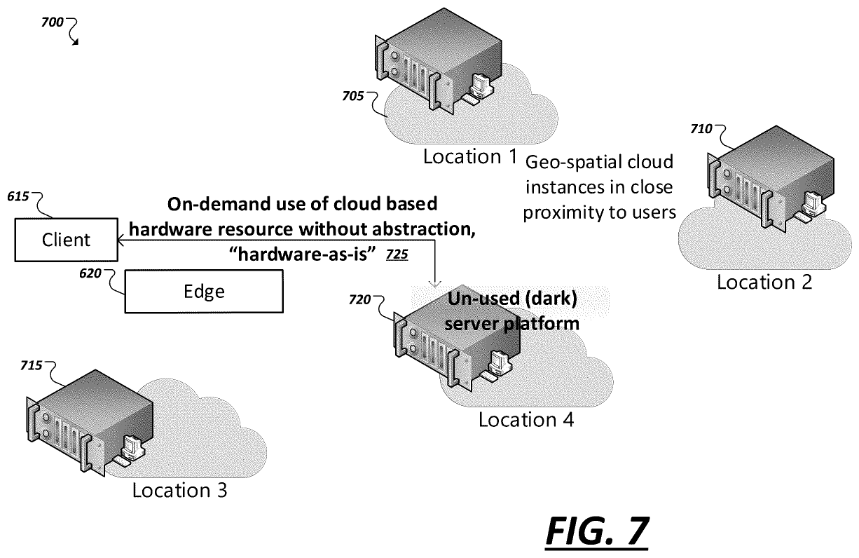

Turning to FIG. 7, a simplified block diagram 700 is shown of an improved solution, where cloud or data center resources are shared with edge system (e.g., 615, 620) to operate as a cloud-as-an-extension-to-client/edge with as-is-hardware. Such a solution can enable improved hardware transparency, re-use of infrastructure, portability, among other example benefits. Managers of client and/or edge systems may subscribe to be customers of a CSP offering bare metal as-is for lease. The cloud system may include a variety of hardware resources (e.g., 705, 710, 715, 720) across one or multiple geographical locations (e.g., in one or more multiple data centers), which may from time-to-time be considered “unused”, for instance, based on the hardware resource (e.g., server node) being in a low power state, in an idle state, not processing a workload of another application, or other inactive state for a threshold amount or percentage of time. In such cases, the cloud system may identify particular hardware (e.g., 720) as unused and may make the same hardware available to a requester requesting use of hardware as-is from the cloud system. For instance, in the example of FIG. 7, a server platform 720 may be determined to be unused and may be offered up by a cloud system as server hardware available to be temporarily controlled and managed by a customer (e.g., 615, 620). In this example, a client device 615 of a customer is used to access and control hardware of server 720 within a hardware-as-is offering.

In an example implementation of a hardware-as-is offering, when hardware of a cloud platform is shared with an edge or client system, it is equivalent of having the cloud-resource platform locally on-premise with the same edge or client. In some implementations, an orchestrator on the customer device (e.g., edge 620 or client 615) is provided with a dedicated interface to the cloud system to request and provision un-used hardware at the cloud data center. The orchestrators on the customer devices, upon being granted exclusive control of a particular unused cloud hardware resource, may manage hardware power and network ports of the unused hardware similar to how the orchestrator would manage power and networking ports on-premise. In some implementations, display and I/O ports of the leased hardware may be forwarded over the network coupling the customer device to the unused cloud hardware (e.g., with direct forwarding). The cloud management utilities are locked out of managing the unused cloud hardware while it is leased by a customer in an hardware-as-is session and may not be granted visibility to either network or I/O information being forwarded to the customer (e.g., edge- or client-based) orchestrators within the session. Management and control communication between the customer device and the leased unused cloud hardware may be secured, for instance, through end-to-end encryption (e.g., HTTPS) of data-forwarding (e.g., using defined REST API methods), among other example features.

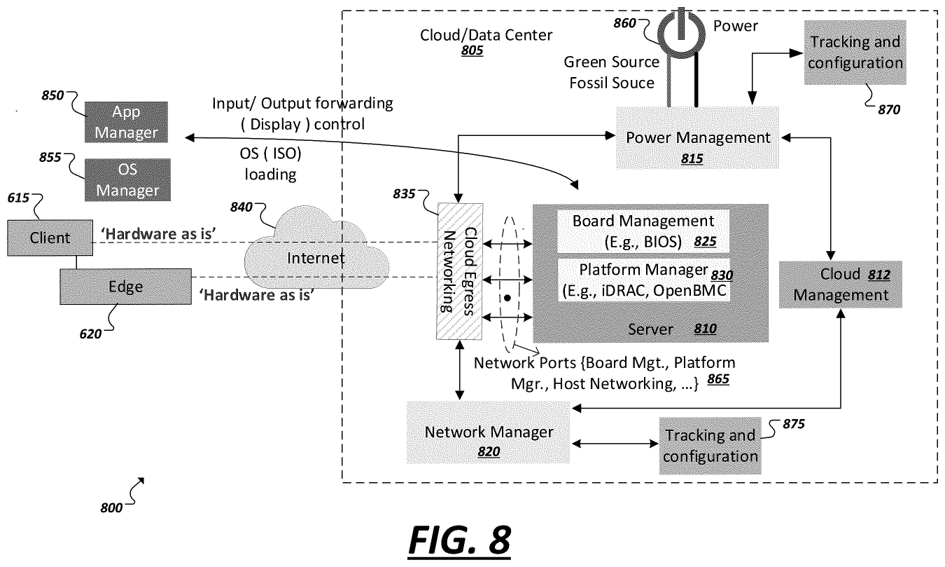

Turning to FIG. 8, a simplified block diagram 800 is shown illustrating an example data center or cloud server system (e.g., 805) including a server 810 with various hardware configured to execute various programs, applications, and threads within various workflows, as directed by an orchestrator. The server 810 may include processors (e.g., central processing units (CPUs), graphics processing units (GPUs), tensor processing units (TPUs), FPGA devices, hardware accelerators, etc.), memory elements, I/O and networking hardware, memory management hardware, power management hardware, among other example hardware resources. The server 810 may have an associated network manager subsystem 820 to manage network connections of the server (e.g., using network ports 865) and an associated power management subsystem 815 for managing power usage and states of the elements of the server 810 (e.g., as provided by one or more power sources (e.g., 860). When in normal use within the cloud system or data center, board management, platform management 830, power management 815, and network management 820 may be managed and governed by cloud orchestration and management logic in connection with cloud-based services and workloads offered by the data center 805. For instance, a cloud management subsystem 812 may be provided, which interfaces with server management blocks (e.g., 815, 820)

The data center 805 may receive and manage hardware-as-is service requests, as well as determine which servers are in an “unused” state or not and may be offered to customers in response to hardware-as-is service requests. Client or edge systems (e.g., 615, 620) of the customer may access the data center 805 via one or more networks (e.g., 840) and may communicate hardware-as-is service requests to the data center 805 (via cloud egress networking hardware 835). The data center 805 may identify a server (e.g., 810) available for the request and may establish a secure session between the server 810 and the customer device (e.g., 615, 620). Within a hardware-as-is service session, control of the unused hardware is given over to the customer device, with the data center 805 locking access to the server 810 and its resources to other requestors, including requestors and workflows within the data center 805. In a hardware-as-is service session, secure communication channels are established between the hardware elements of the server and the customer device(s) (e.g., 615, 620) using cloud egress networking 835. The customer device may thereby access and control the power manager 815, network manager 820, board and platform management utilities (e.g., 825, 830), among other hardware and management resources of the server 810 and cause the server 810 to execute various workloads as managed by management utilities (e.g., application manager 850, operating system (OS) manager 855, etc.) of the edge or client system.

In some implementations, while a particular cloud hardware resource (e.g., server 810) is locked and leased to a customer within a hardware-as-is service session, the hardware resource may be considered “busy” and may remain locked until the customer system (e.g., 615, 620) sends an indication (e.g., to the cloud management subsystem 810) that the customer desires to end the session and hand control of the resources back to the cloud or data center 805 (e.g., where the resources are once again managed and controlled by the data center's own orchestration logic). In some implementations, the hardware-as-is service session may be commercialized, for instance, through the monitoring of the length (in time) of the session, the type of resources or server nodes leased, the amount of data processed or sent over network ports of the leased hardware, the amount of power used during the session, among other factors. Accordingly, in some implementations, tracking and configuration blocks (e.g., 870, 875) may be provided to passively monitor the use of leased hardware within a hardware-as-is service session, to determine fees to charge in connection with the hardware-as-is service session.

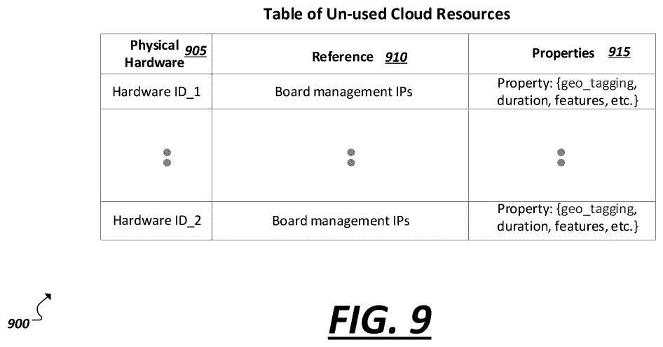

A cloud computing system or data center offering hardware-as-is services may continuously monitor its hardware resources (e.g., server nodes or other blocks or collections of hardware) to determine which hardware, at any given moment, is currently in an unused state and may be offered for customers in hardware-as-is service sessions. For instance, one or more tables or other data may be maintained by the cloud computing system to identify which hardware resources are currently in an unused state. In addition to maintaining the usage status of various cloud hardware resources, the cloud system may also identify the type of hardware included in the resources, their capabilities, their geographical location, and other attributes, together within data identifying when the hardware resources entered the unused state, how long the hardware resources have been in the unused state, as well as information concerning past hardware-as-is service sessions involving the hardware (e.g., to establish affinities between customers and particular hardware or hardware types, to assist in identifying hardware resources of interest to a given customer in response to their session request, to enable a customer to re-lease hardware or similar hardware that the customer successfully leased in the past, etc.). FIG. 9 is an example simplified representation of an unused cloud resources table 900 capable of being maintained and used by an example cloud computing system. For instance, the table 900 may identify (e.g., by hardware identifier at 905) the various hardware that are currently unused (and available for lease), as well as information describing the type and functionality of the hardware resources (e.g., at 910). Additional properties (at 915) may also be maintained, including geo location of the resources (e.g., to assist edge systems in selecting and leasing cloud resources that are within the geographic proximity of the edge system), among other features of the hardware's use and availability, among other information.

The tracking of the pool of unused hardware resources within a cloud system may additional used to ensure that the normal operation of the cloud is uninterrupted by the decoupling of hardware instances from the cloud-management in hardware-as-is service sessions. When connected to the centralized managed framework, the platforms are either actively managed within the cloud system for new workloads, or passively managed for background workloads, or new demand provisioning. As a result, the unused pool keeps track of platforms which are in a low power, shutdown, or idle state and have no currently active or passive role in the data center (cloud) operations. In some implementations, computing platforms and hardware that are in unused states may be marked as “dark-servers” and cut off from other server systems in the cloud, having high wake-up times.

Each platform (hardware node) may be tagged with markers (e.g., as shown in the example of FIG. 9). Some of the important parameters may include board management IPs of the platform, I/O redirection addresses (e.g., IP addresses), geo-tagging, and so on. Each hardware platform (e.g., server node) may be tracked by a respective hardware identifier (e.g., 905), which is mapped to hardware characteristics as observed for the hardware during its last active periods. Such characteristics may be used (e.g., in connection with geo-location) to identify platform that can be assigned to respective, requesting client/edge management system of various customers of the cloud server. For instance, the client/edge management of a particular customer can request and gain access to desired hardware resources that fit it current demands and policies and obtain complete hardware control of the resources including its power, platform management, and network port configurations. In some implementations, the pool of unused hardware resources may also track which hardware resources have been assigned to and are in use by a respective hardware-as-is service session. When the session completes, the cloud system utility managing the unused hardware resource table may update the status of the resources leased in the session, such these resources may return to the pool of hardware available for hardware-as-is service sessions or may be removed as “unused” resources, such that the resources may instead be accessed and used in future in workloads of the cloud system, among other examples.

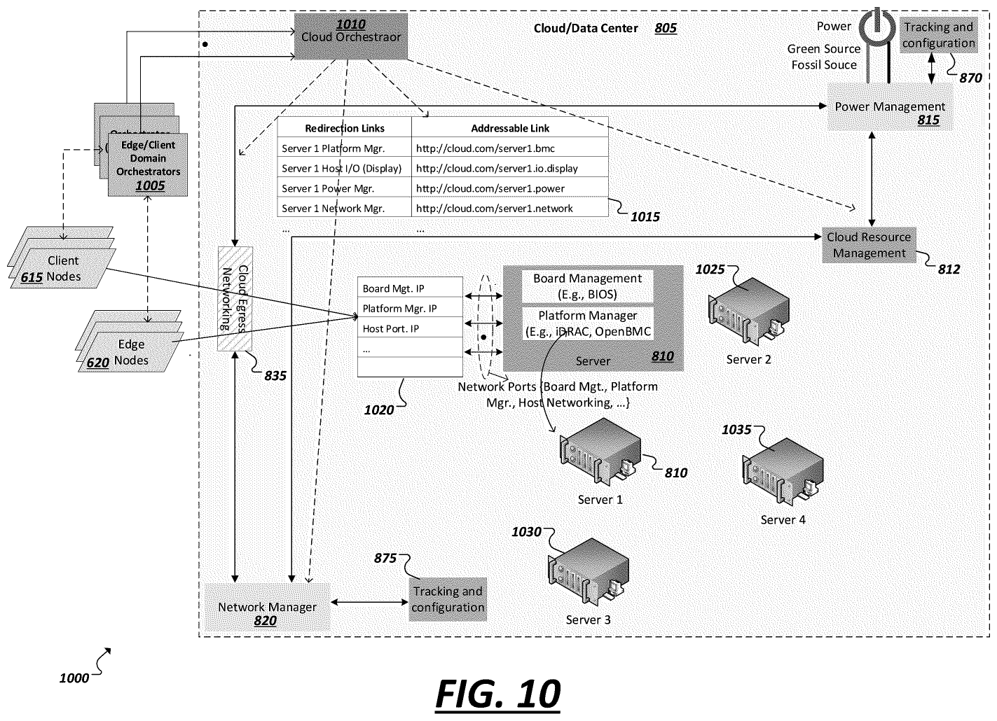

Turning to FIG. 10, a simplified block diagram 1000 is shown illustrating an example cloud system or data center system 805 configured to support hardware-as-is sessions. In this example, the cloud system 805 may include a network of multiple server platforms or server nodes (e.g., 810, 1025, 1030, 1035, etc.). A table or other record may be maintained by the cloud system 805 (e.g., using cloud orchestrator 1010) to track which server nodes (e.g., 810, 1025, 1030, 1035) are in use or active within the cloud system (e.g., and available for provisioning to handle cloud-system-based workloads, for instance, because the server node does not need to emerge from a low power, sleep, or inactive state). The cloud orchestrator 1010 may also identify the functionality and hardware resources available on each respective server node, the geolocation of each server node (e.g., where the cloud system is distributed over multiple physical data centers), as well as whether an “unused” server node is currently leased-out in a hardware-as-is session, among other information (e.g., using a table of unused cloud assets similar to the example of FIG. 9).

Continuing with the example of FIG. 10, an orchestrator (e.g., 1005) of an edge or client system of a customer may send requests to the cloud system 805 (e.g., for handling by cloud orchestrator logic 1010) to lease, in a hardware-as-is session, a hardware instance of the cloud system (e.g., 810, 1025, 1030, 1035) with specific characteristics such as preferred geo-instance, hardware elements (e.g., particular processor hardware; particular network, compute, or memory capacity; particular hardware accelerators, etc.). Indeed, the request may include a format (e.g., defined fields) to indicate the desired characteristics of the hardware instance to be independently managed by the edge/client orchestrators 1005 in the hardware-as-is session.

To facilitate a hardware-as-is session, the cloud orchestrator of the cloud system 805 may generate session-specific redirection links (e.g., 1015) and securely share these links with the edge 615 or client node 620 of the customer who will lease a given cloud hardware platform (e.g., 810). An authentication protocol may also be utilized to authenticate the customer node (e.g., 615, 620), such that only the authorized customer is able to successfully utilize the redirection links 1015 and access the corresponding hardware resources of the hardware platform 810. In some implementations, communications sent by the customer node via the cloud system's cloud egress networking circuitry and logic (e.g., 835) may include an authentication token or other data to continuously authenticate and secure the communications (and control facilitated through the communications) between the customer node and the leased cloud hardware platform 810, among other example features and implementations. The cloud egress networking logic 835 may further perform a domain name system (DNS)-like redirection link lookup (e.g., using a redirection table 1015) to cause communications from the customer nodes that include a given redirection link to be routed to the appropriately mapped addressable link (e.g., IP address 1020) of the various hardware resources (e.g., board management, platform management, host I/O, power management 815, network management 820, etc.) of the leased platform 810, among other example implementations.

Among the communications, which may be sent from the customer node (e.g., 615, 620) during a secured, hardware-as-is session, may be a message to indicate that the customer has concluded their use of the leased hardware platform and wishes to end the corresponding hardware-as-is session. The cloud orchestrator 1010, in response to receiving an end session message from the customer node, may cause the cloud system 805 to reclaim control of the hardware platform by effectively locking out the customer node by cancelling the redirection links 1015 that have been generated for the hardware-as-is session, thereby closing the customer's ability to directly control the hardware resources of the hardware platform (e.g., through commands to the board management, platform management, network management, and power management, etc.). The cloud orchestrator 1010 may then cause the hardware platform to be returned to the pool of assets available for the cloud system's workloads or allow the hardware platform to return to an unused state and be made available to other edge customers who may wish to lease the hardware platform 810 in another, later hardware-as-is session, among other example features and implementations.

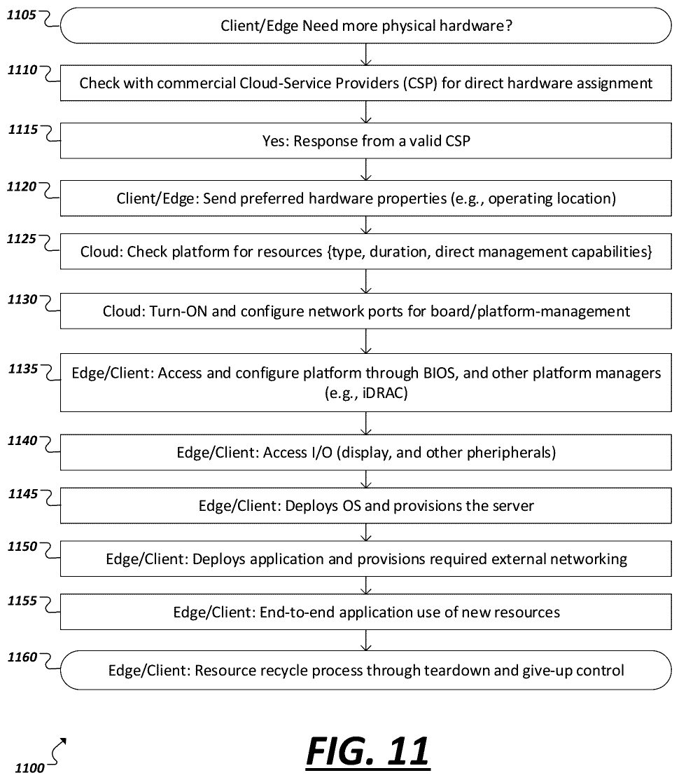

Turning to FIG. 11, a simplified flow diagram 1100 is shown illustrating an example technique for providing hardware-as-is sessions allowing edge systems to secure independent control of unused cloud system hardware platforms (e.g., server nodes). For instance, a client or edge system may determine 1105 (e.g., prior to launching execution of a workload, service, or application or after launching the application and determining, dynamically, that additional or enhanced hardware resources are needed to implement the application (e.g., in accordance with particular SLAs or other policies)) that additional or enhanced hardware resources are needed for its workload or application. The edge system may query 1110 a cloud system (e.g., with which it has a customer-vendor relationship) to determine if direct hardware assignment via a hardware-as-is session would be available. The edge system may receive (at 1115) an affirmative response and send 1120 a request for a hardware-as-is session to temporarily takeover and have exclusive control of an unused or otherwise available hardware platform having a desired set of characteristics, hardware resources, functionality, geographic locality, and/or capabilities. The cloud system may respond to the request by determining 1125 whether unused hardware platforms are available that meet (or best meet) the requested characteristics. If such a hardware platform is found to be available, the cloud system may initiate 1130 the requested hardware-as-is session, for instance, by configuring network ports (e.g., with dedicated, session-specific redirection links) for direct management access by the edge system. Through these links, an orchestrator or other logic on the edge system may access and configure 1135 the leased, unused hardware platform, for instance through the hardware platform BIOS or other platform management blocks. In some instances, the edge system may utilize the hardware platform ports to directly access 1140 the platform I/O to control and utilize other hardware resources of the platform and may deploy 1145 an operating system and provision the hardware platform for use within the edge system's workloads/application. The edge system may then deploy 1150 the application on the leased hardware platform and, in some cases, provision the hardware platform for any external networking to be utilized in the application deployed on the hardware platform. With the OS and application deployed and the leased server provisioned, the edge system, at its direction, may utilize 1155 the leased cloud hardware platform and its component hardware resources in its end-to-end implementation of its application and workflows. When use of the leased hardware platform is complete (e.g., due to the completed execution of the application or workload managed by the edge system), the edge system may tear down 1160 the application logic, operating system, configurations, and related data provisioned onto the hardware platform during the hardware-as-is session and may relinquish control of the hardware platform and end the hardware-as-is session, among other example features.

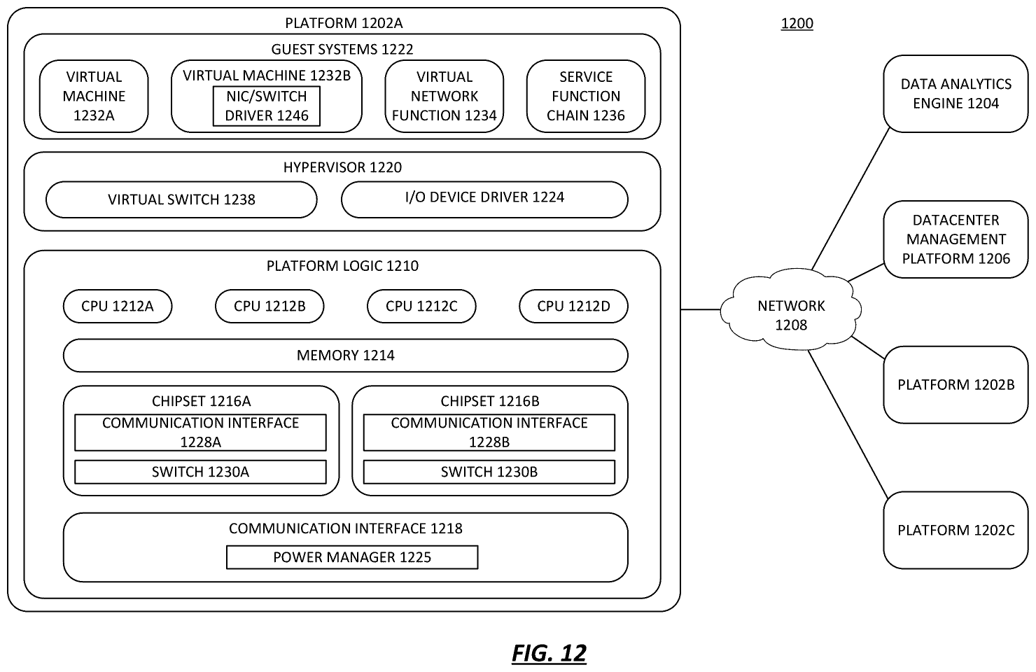

Note that the apparatus, methods, and systems described above may be implemented in any electronic device or system as aforementioned. As a specific illustration, FIG. 12 illustrates a block diagram of components of an example computing platform, such as a server node or other platform included within a cloud computing system or datacenter 1200 in accordance with certain embodiments. In the embodiment depicted, datacenter 1200 includes a plurality of platforms 1202A-C, data analytics engine 1204, and datacenter management platform 1206 coupled together through network 1208. A platform 1202 may include platform logic 1210 with one or more central processing units (CPUs) 1212, memories 1214 (which may include any number of different modules), chipsets 1216, communication interfaces 1218, and any other suitable hardware and/or software to execute a hypervisor 1220 or other operating system capable of executing processes associated with applications running on platform 1202. In some embodiments, a platform 1202 may function as a host platform for one or more guest systems 1222 that invoke these applications. The platform may be logically or physically subdivided into clusters and these clusters may be enhanced through specialized networking accelerators and the use of Compute Express Link (CXL) memory semantics to make such cluster more efficient, among other example enhancements.

Each platform (e.g., 1202A-C) may include platform logic 1210. Platform logic 1210 comprises, among other logic enabling the functionality of platform 1202, one or more CPUs 1212, memory 1214, one or more chipsets 1216, and communication interface 1218. Although three platforms are illustrated, datacenter 1200 may include any suitable number of platforms. In various embodiments, a platform 1202 may reside on a circuit board that is installed in a chassis, rack, compossible servers, disaggregated servers, or other suitable structures that comprises multiple platforms coupled together through network 1208 (which may comprise, e.g., a rack or backplane switch).

CPUs 1212A-D may each comprise any suitable number of processor cores. The cores may be coupled to each other, to memory 1214, to at least one chipset 1216, and/or to communication interface 1218, through one or more controllers residing on CPU 1212 and/or chipset 1216. In particular embodiments, a CPU 1212 is embodied within a socket that is permanently or removably coupled to platform 1202. Although four CPUs are shown, a platform 1202 may include any suitable number of CPUs.

Memory 1214 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 1214 may be used for short, medium, and/or long-term storage by platform 1202. Memory 1214 may store any suitable data or information utilized by platform logic 1210, including software embedded in a computer readable medium, and/or encoded logic incorporated in hardware or otherwise stored (e.g., firmware). Memory 1214 may store data that is used by cores of CPUs 1212. In some embodiments, memory 1214 may also comprise storage for instructions that may be executed by the cores of CPUs 1212 or other processing elements (e.g., logic resident on chipsets 1216) to provide functionality associated with components of platform logic 1210. Additionally or alternatively, chipsets 1216 may each comprise memory that may have any of the characteristics described herein with respect to memory 1214. Memory 1214 may also store the results and/or intermediate results of the various calculations and determinations performed by CPUs 1212 or processing elements on chipsets 1216. In various embodiments, memory 1214 may comprise one or more modules of system memory coupled to the CPUs through memory controllers (which may be external to or integrated with CPUs 1212). In various embodiments, one or more particular modules of memory 1214 may be dedicated to a particular CPU 1212 or other processing device or may be shared across multiple CPUs 1212 or other processing devices.

A platform 1202 may also include one or more chipsets 1216 comprising any suitable logic to support the operation of the CPUs 1212. In various embodiments, chipset 1216 may reside on the same package as a CPU 1212 or on one or more different packages. Each chipset may support any suitable number of CPUs 1212. A chipset 1216 may also include one or more controllers to couple other components of platform logic 1210 (e.g., communication interface 1218 or memory 1214) to one or more CPUs. Additionally or alternatively, the CPUs 1212 may include integrated controllers. For example, communication interface 1218 could be coupled directly to CPUs 1212 via integrated I/O controllers resident on each CPU.

Chipsets 1216 may each include one or more communication interfaces 1228. Communication interface 1228 may be used for the communication of signaling and/or data between chipset 1216 and one or more I/O devices, one or more networks 1208, and/or one or more devices coupled to network 1208 (e.g., datacenter management platform 1206 or data analytics engine 1204). For example, communication interface 1228 may be used to send and receive network traffic such as data packets. In a particular embodiment, communication interface 1228 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 1216 (e.g., switch 1230) and another device coupled to network 1208. In some embodiments, network 1208 may comprise a switch with bridging and/or routing functions that is external to the platform 1202 and operable to couple various I/O controllers (e.g., NICs) distributed throughout the datacenter 1200 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 1228 may also allow I/O devices integrated with or external to the platform (e.g., disk drives, other NICs, etc.) to communicate with the CPU cores.

Switch 1230 may couple to various ports (e.g., provided by NICs) of communication interface 1228 and may switch data between these ports and various components of chipset 1216 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 1230 may be a physical or virtual (e.g., software) switch.

Platform logic 1210 may include an additional communication interface 1218. Similar to communication interface 1228, communication interface 1218 may be used for the communication of signaling and/or data between platform logic 1210 and one or more networks 1208 and one or more devices coupled to the network 1208. For example, communication interface 1218 may be used to send and receive network traffic such as data packets. In a particular embodiment, communication interface 1218 comprises one or more physical I/O controllers (e.g., NICs). These NICs may enable communication between any suitable element of platform logic 1210 (e.g., CPUs 1212) and another device coupled to network 1208 (e.g., elements of other platforms or remote nodes coupled to network 1208 through one or more networks). In particular embodiments, communication interface 1218 may allow devices external to the platform (e.g., disk drives, other NICs, etc.) to communicate with the CPU cores. In various embodiments, NICs of communication interface 1218 may be coupled to the CPUs through I/O controllers (which may be external to or integrated with CPUs 1212). Further, as discussed herein, I/O controllers may include a power manager 1225 to implement power consumption management functionality at the I/O controller (e.g., by automatically implementing power savings at one or more interfaces of the communication interface 1218 (e.g., a PCIe interface coupling a NIC to another element of the system), among other example features.

Platform logic 1210 may receive and perform any suitable types of processing requests. A processing request may include any request to utilize one or more resources of platform logic 1210, such as one or more cores or associated logic. For example, a processing request may comprise a processor core interrupt; a request to instantiate a software component, such as an I/O device driver 1224 or virtual machine 1232; a request to process a network packet received from a virtual machine 1232 or device external to platform 1202 (such as a network node coupled to network 1208); a request to execute a workload (e.g., process or thread) associated with a virtual machine 1232, application running on platform 1202, hypervisor 1220 or other operating system running on platform 1202; or other suitable request.

In various embodiments, processing requests may be associated with guest systems 1222. A guest system may comprise a single virtual machine (e.g., virtual machine 1232a or 1232b) or multiple virtual machines operating together (e.g., a virtual network function (VNF) 1234 or a service function chain (SFC) 1236). As depicted, various embodiments may include a variety of types of guest systems 1222 present on the same platform 1202.

A virtual machine 1232 may emulate a computer system with its own dedicated hardware. A virtual machine 1232 may run a guest operating system on top of the hypervisor 1220. The components of platform logic 1210 (e.g., CPUs 1212, memory 1214, chipset 1216, and communication interface 1218) may be virtualized such that it appears to the guest operating system that the virtual machine 1232 has its own dedicated components.

A virtual machine 1232 may include a virtualized NIC (vNIC), which is used by the virtual machine as its network interface. A vNIC may be assigned a media access control (MAC) address, thus allowing multiple virtual machines 1232 to be individually addressable in a network.

In some embodiments, a virtual machine 1232b may be paravirtualized. For example, the virtual machine 1232b may include augmented drivers (e.g., drivers that provide higher performance or have higher bandwidth interfaces to underlying resources or capabilities provided by the hypervisor 1220). For example, an augmented driver may have a faster interface to underlying virtual switch 1238 for higher network performance as compared to default drivers.

VNF 1234 may comprise a software implementation of a functional building block with defined interfaces and behavior that can be deployed in a virtualized infrastructure. In particular embodiments, a VNF 1234 may include one or more virtual machines 1232 that collectively provide specific functionalities (e.g., wide area network (WAN) optimization, virtual private network (VPN) termination, firewall operations, load-balancing operations, security functions, etc.). A VNF 1234 running on platform logic 1210 may provide the same functionality as traditional network components implemented through dedicated hardware. For example, a VNF 1234 may include components to perform any suitable NFV workloads, such as virtualized Evolved Packet Core (vEPC) components, Mobility Management Entities, 3rd Generation Partnership Project (3GPP) control and data plane components, etc.

SFC 1236 is group of VNFs 1234 organized as a chain to perform a series of operations, such as network packet processing operations. Service function chaining may provide the ability to define an ordered list of network services (e.g., firewalls, load balancers) that are stitched together in the network to create a service chain.

A hypervisor 1220 (also known as a virtual machine monitor) may comprise logic to create and run guest systems 1222. The hypervisor 1220 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 1210. Services of hypervisor 1220 may be provided by virtualizing in software or through hardware assisted resources that require minimal software intervention, or both. Multiple instances of a variety of guest operating systems may be managed by the hypervisor 1220. Each platform 1202 may have a separate instantiation of a hypervisor 1220.

Hypervisor 1220 may be a native or bare-metal hypervisor that runs directly on platform logic 1210 to control the platform logic and manage the guest operating systems. Alternatively, hypervisor 1220 may be a hosted hypervisor that runs on a host operating system and abstracts the guest operating systems from the host operating system. Various embodiments may include one or more non-virtualized platforms 1202, in which case any suitable characteristics or functions of hypervisor 1220 described herein may apply to an operating system of the non-virtualized platform.

Hypervisor 1220 may include a virtual switch 1238 that may provide virtual switching and/or routing functions to virtual machines of guest systems 1222. The virtual switch 1238 may comprise a logical switching fabric that couples the vNICs of the virtual machines 1232 to each other, thus creating a virtual network through which virtual machines may communicate with each other. Virtual switch 1238 may also be coupled to one or more networks (e.g., network 1208) via physical NICs of communication interface 1218 so as to allow communication between virtual machines 1232 and one or more network nodes external to platform 1202 (e.g., a virtual machine running on a different platform 1202 or a node that is coupled to platform 1202 through the Internet or other network). Virtual switch 1238 may comprise a software element that is executed using components of platform logic 1210. In various embodiments, hypervisor 1220 may be in communication with any suitable entity (e.g., a SDN controller) which may cause hypervisor 1220 to reconfigure the parameters of virtual switch 1238 in response to changing conditions in platform 1202 (e.g., the addition or deletion of virtual machines 1232 or identification of optimizations that may be made to enhance performance of the platform).

Hypervisor 1220 may include any suitable number of I/O device drivers 1224. I/O device driver 1224 represents one or more software components that allow the hypervisor 1220 to communicate with a physical I/O device. In various embodiments, the underlying physical I/O device may be coupled to any of CPUs 1212 and may send data to CPUs 1212 and receive data from CPUs 1212. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 1212. In one example, the underlying I/O device is a physical NIC or physical switch. For example, in one embodiment, the underlying I/O device of I/O device driver 1224 is a NIC of communication interface 1218 having multiple ports (e.g., Ethernet ports).

In other embodiments, underlying I/O devices may include any suitable device capable of transferring data to and receiving data from CPUs 1212, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 1224 or the underlying I/O device may send an interrupt (such as a message signaled interrupt) to any of the cores of the platform logic 1210. For example, the I/O device driver 1224 may send an interrupt to a core that is selected to perform an operation (e.g., on behalf of a virtual machine 1232 or a process of an application). Before the interrupt is delivered to the core, incoming data (e.g., network packets) destined for the core might be cached at the underlying I/O device and/or an I/O block associated with the CPU 1212 of the core. In some embodiments, the I/O device driver 1224 may configure the underlying I/O device with instructions regarding where to send interrupts.

In some embodiments, as workloads are distributed among the cores, the hypervisor 1220 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 1232 can be balanced across cores using network load and traffic patterns rather than just CPU and memory utilization metrics.

The elements of platform logic 1210 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 1200 may be coupled together in any suitable, manner such as through one or more networks 1208. A network 1208 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 1222 may communicate with nodes that are external to the datacenter 1200 through network 1208.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is a non-transitory, machine-readable storage medium with instructions stored thereon, where the instructions are executable by a machine to cause the machine to: determine that a server platform in a set of server platforms in a data center system is in an unused state; identify a request from a remote computing system outside the data center system to control hardware of at least one of the set of server platforms; initiate a bare-metal-as-is (BMAI) session for the remote computing system to use the server platform based on the unused state, where control of at least a portion of hardware of the server platform is temporarily handed over from an orchestrator of the data center system to the remote computing system in the BMAI session; and reclaim control of the portion of the hardware of the server platform based on an end of the BMAI session.

Example 2 includes the subject matter of example 1, where the BMAI session includes a session for bare metal control of the server platform at the direction of the remote computing system.

Example 3 includes the subject matter of any one of examples 1-2, where the data center system is further to initiate a bare metal as a service (BMaaS) session for the remote computing system, where the remote computing system is permitted usage of at least the portion of the hardware of the server platform in the BMaaS session under control of an orchestrator of the data center system, and control of at least the portion of the hardware of the service platform by the orchestrator is disabled during the BMAI session.

Example 4 includes the subject matter of example 3, where an orchestrator executed on the remote computing system controls at least the portion of the hardware of the service platform during the BMAI session.

Example 5 includes the subject matter of example 3, where at least the portion of the hardware of the service platform is used to execute workloads in a cloud-based application within the data center after control of the portion of the hardware of the server platform is reclaimed, and the orchestrator controls at least the portion of the hardware of the server platform during execution of the workloads in the cloud-based application.

Example 6 includes the subject matter of example 5, where the server platform is determined to be in an unused state based on a determination that the server platform has not been used in a workload of the data center for at least a duration.

Example 7 includes the subject matter of any one of examples 5-6, where the instructions are further executable to cause a machine to: initiate another cloud-based application within the data center; determine that the server platform is locked during the BMAI session; and select an alternate server platform for use in execution of the other cloud-based application based on the server platform being locked.

Example 8 includes the subject matter of any one of examples 1-7, where the server platform is determined to be in an unused state based on a determination that the server platform is in a low power state.

Example 9 includes the subject matter of any one of examples 1-8, where the instructions are further executable to cause a machine to: generate a set of redirection links for the BMAI session, where the set of redirection links correspond to a set of addresses of a set of hardware managers for the server platform; communicate the set of redirection links to the remote computing device in association with initiation of the BMAI session; and route a message from the remote computing device to a corresponding one of the set of hardware managers based on inclusion of one of the set of redirection links in the message, where the message is to control the one of the set of hardware managers.

Example 10 includes the subject matter of example 9, where the set of hardware managers includes at least one of a network manager, a baseboard manager, a platform manager, or a power manager.

Example 11 includes the subject matter of any one of examples 9-10, where the set of redirection links are cancelled to reclaim control of the server platform.

Example 12 includes the subject matter of any one of examples 1-11, where the instructions are further executable to cause a machine to: generate a security token for the BMAI session; and authenticate communications to the server platform during the BMAI session based on the security token.

Example 13 includes the subject matter of any one of examples 1-12, where the portion of the hardware of the server platform includes one or more of a processor, a hardware accelerator, a memory, power management hardware, or networking hardware.

Example 14 includes the subject matter of any one of examples 1-13, where the remote computing system includes an edge computing device.

Example 15 includes the subject matter of any one of examples 1-14, where the remote computing system implements an application using the portion of the hardware of the server platform together with hardware of the remote computing system.

Example 16 is a method including: determining that a server platform in a set of server platforms in a data center system is in an unused state; identifying a request from a remote computing system outside the data center system to control hardware of at least one of the set of server platforms; initiating a bare-metal-as-is (BMAI) session for the remote computing system to use the server platform based on the unused state, where exclusive control of at least a portion of hardware of the server platform is temporarily handed over to the remote computing system in the BMAI session; and reclaiming control of the portion of the hardware of the server platform based on an end of the BMAI session.

Example 17 includes the subject matter of example 16, where the BMAI session includes a session for bare metal control of the server platform at the direction of the remote computing system.

Example 18 includes the subject matter of any one of examples 16-17, where the data center system is further to initiate a bare metal as a service (BMaaS) session for the remote computing system, where the remote computing system is permitted usage of at least the portion of the hardware of the server platform in the BMaaS session under control of an orchestrator of the data center system, and control of at least the portion of the hardware of the service platform by the orchestrator is disabled during the BMAI session.

Example 19 includes the subject matter of example 18, where an orchestrator executed on the remote computing system controls at least the portion of the hardware of the service platform during the BMAI session.

Example 20 includes the subject matter of example 18, where at least the portion of the hardware of the service platform is used to execute workloads in a cloud-based application within the data center after control of the portion of the hardware of the server platform is reclaimed, and the orchestrator controls at least the portion of the hardware of the server platform during execution of the workloads in the cloud-based application.

Example 21 includes the subject matter of example 20, where the server platform is determined to be in an unused state based on a determination that the server platform has not been used in a workload of the data center for at least a duration.

Example 22 includes the subject matter of any one of examples 20-21, further including: initiating another cloud-based application within the data center; determining that the server platform is locked during the BMAI session; and selecting an alternate server platform for use in execution of the other cloud-based application based on the server platform being locked.

Example 23 includes the subject matter of any one of examples 16-22, where the server platform is determined to be in an unused state based on a determination that the server platform is in a low power state.

Example 24 includes the subject matter of any one of examples 16-23, further including: generating a set of redirection links for the BMAI session, where the set of redirection links correspond to a set of addresses of a set of hardware managers for the server platform; communicating the set of redirection links to the remote computing device in association with initiation of the BMAI session; and routing a message from the remote computing device to a corresponding one of the set of hardware managers based on inclusion of one of the set of redirection links in the message, where the message is to control the one of the set of hardware managers.

Example 25 includes the subject matter of example 24, where the set of hardware managers includes at least one of a network manager, a baseboard manager, a platform manager, or a power manager.

Example 26 includes the subject matter of any one of examples 24-25, where the set of redirection links are cancelled to reclaim control of the server platform.

Example 27 includes the subject matter of any one of examples 16-26, where the instructions are further executable to cause a machine to: generate a security token for the BMAI session; and authenticate communications to the server platform during the BMAI session based on the security token.

Example 28 includes the subject matter of any one of examples 16-27, where the portion of the hardware of the server platform includes one or more of a processor, a hardware accelerator, a memory, power management hardware, or networking hardware.

Example 29 includes the subject matter of any one of examples 16-28, where the remote computing system includes an edge computing device.

Example 30 includes the subject matter of any one of examples 16-29, where the remote computing system implements an application using the portion of the hardware of the server platform together with hardware of the remote computing system.

Example 31 is a system including means to perform the method of any one of examples 16-30.

Example 32 is a system including: an edge computing device; and a cloud computing system coupled to the edge computing device over a wireless network connection, the cloud computing system including: a network including a plurality of server platforms; an orchestrator to control hardware of at least a particular one of the plurality of server platforms; a session manager, executable by a processor of one of the plurality of server platforms to: determine that the particular server platform is in an unused state; identify a request from the edge computing device for a bare-metal-as-is (BMAI) session with the cloud computing system; initiate the BMAI session for the edge computing device to use the particular server platform based on the unused state, where exclusive control of at least a portion of hardware of the particular server platform is temporarily granted to the edge computing device and control by the orchestrator is disabled in the BMAI session; and end the BMAI session to restore control of the portion of the hardware of the particular server platform to the orchestrator.

Example 33 includes the subject matter of example 32, where the edge computing device includes an edge orchestrator to orchestrate a workload in an edge computing environment, where the edge orchestrator is to: determine that additional hardware resources are to be used to execute the workload; generate the request for the BMAI session to access the additional hardware resources for use in execution of the workload; and control the portion of the hardware of the particular service platform during the BMAI session in connection execution of the workload.

Example 34 includes the subject matter of example 32, where the request for the BMAI session includes requested characteristics of hardware from the cloud computing system, and the particular server platform is selected for use in the BMAI session based on the requested characteristics.

Example 35 includes the subject matter of example 34, where the requested characteristics includes at least one of a listing of required hardware elements, a listing of required capabilities, or a geographic location for the hardware.

Example 36 includes the subject matter of any one of examples 32-35, where the BMAI session includes a session for bare metal control of the server platform at the direction of the remote computing system.

Example 37 includes the subject matter of any one of examples 32-36, where the server platform is determined to be in an unused state based on a determination that the server platform is in a low power state.

Example 38 includes the subject matter of any one of examples 32-37, where the session manager is further executable to: generate a set of redirection links for the BMAI session, where the set of redirection links correspond to a set of addresses of a set of hardware managers for the server platform; communicate the set of redirection links to the remote computing device in association with initiation of the BMAI session; and route a message from the remote computing device to a corresponding one of the set of hardware managers based on inclusion of one of the set of redirection links in the message, where the message is to control the one of the set of hardware managers.

Example 39 includes the subject matter of example 38, where the set of hardware managers includes at least one of a network manager, a baseboard manager, a platform manager, or a power manager.

Example 40 includes the subject matter of any one of examples 38-39, where the set of redirection links are cancelled to reclaim control of the server platform.

Example 41 includes the subject matter of any one of examples 32-40, where the session manager is further executable to: generate a security token for the BMAI session; and authenticate communications to the server platform during the BMAI session based on the security token.

Example 42 includes the subject matter of any one of examples 32-41, where the portion of the hardware of the server platform includes one or more of a processor, a hardware accelerator, a memory, power management hardware, or networking hardware.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. At least one machine-readable storage medium with instructions stored thereon, wherein the instructions are executable by a machine to cause the machine to:
determine that a server platform in a set of server platforms in a data center system is in an unused state;
identify a request from a remote computing system outside the data center system to control hardware of at least one of the set of server platforms;
initiate a session for the remote computing system to use the server platform based on the unused state, wherein control of at least a portion of hardware of the server platform is temporarily handed over from an orchestrator of the data center system to the remote computing system in the session; and
reclaim control of the portion of the hardware of the server platform based on an end of the session.

2. The storage medium of claim 1, wherein the session comprises a session for bare metal control of the server platform at the direction of the remote computing system.

3. The storage medium of claim 1, wherein the data center system is further to initiate a bare metal as a service (BMaaS) session for the remote computing system, wherein the remote computing system is permitted usage of at least the portion of the hardware of the server platform in the BMaaS session under control of an orchestrator of the data center system, and control of at least the portion of the hardware of the service platform by the orchestrator is disabled during the session.

4. The storage medium of claim 3, wherein an orchestrator executed on the remote computing system controls at least the portion of the hardware of the service platform during the session.

5. The storage medium of claim 3, wherein at least the portion of the hardware of the service platform is used to execute workloads in a cloud-based application within the data center after control of the portion of the hardware of the server platform is reclaimed, and the orchestrator controls at least the portion of the hardware of the server platform during execution of the workloads in the cloud-based application.

6. The storage medium of claim 5, wherein the server platform is determined to be in an unused state based on a determination that the server platform has not been used in a workload of the data center for at least a duration.

7. The storage medium of claim 5, wherein the instructions are further executable to cause a machine to:
initiate another cloud-based application within the data center;
determine that the server platform is locked during the session; and
select an alternate server platform for use in execution of the other cloud-based application based on the server platform being locked.

8. The storage medium of claim 1, wherein the server platform is determined to be in an unused state based on a determination that the server platform is in a low power state.

9. The storage medium of claim 1, wherein the instructions are further executable to cause a machine to:
generate a set of redirection links for the session, wherein the set of redirection links correspond to a set of addresses of a set of hardware managers for the server platform;
communicate the set of redirection links to the remote computing device in association with initiation of the session;
route a message from the remote computing device to a corresponding one of the set of hardware managers based on inclusion of one of the set of redirection links in the message, wherein the message is to control the one of the set of hardware managers.

10. The storage medium of claim 9, wherein the set of hardware managers comprises at least one of a network manager, a baseboard manager, a platform manager, or a power manager.

11. The storage medium of claim 9, wherein the set of redirection links are cancelled to reclaim control of the server platform.

12. The storage medium of claim 1, wherein the instructions are further executable to cause a machine to:
generate a security token for the session; and
authenticate communications to the server platform during the session based on the security token.

13. The storage medium of claim 1, wherein the portion of the hardware of the server platform comprises one or more of a processor, a hardware accelerator, a memory, power management hardware, or networking hardware.

14. The storage medium of claim 1, wherein the remote computing system comprises an edge computing device.

15. The storage medium of claim 1, wherein the remote computing system implements an application using the portion of the hardware of the server platform together with hardware of the remote computing system.

16. A method comprising:
determining that a server platform in a set of server platforms in a data center system is in an unused state;
identifying a request from a remote computing system outside the data center system to control hardware of at least one of the set of server platforms;
initiating a bare-metal-as-is (BMAI) session for the remote computing system to use the server platform based on the unused state, wherein control of at least a portion of hardware of the server platform is temporarily handed over to the remote computing system in the BMAI session; and
reclaiming control of the portion of the hardware of the server platform based on an end of the BMAI session.

17. A system comprising:
an edge computing device; and
a cloud computing system coupled to the edge computing device over a wireless network connection, the cloud computing system comprising:
a network comprising a plurality of server platforms;
an orchestrator to control hardware of at least a particular one of the plurality of server platforms;
a session manager, executable by a processor of one of the plurality of server platforms to:
determine that the particular server platform is in an unused state;
identify a request from the edge computing device for a bare-metal-as-is (BMAI) session with the cloud computing system;
initiate the BMAI session for the edge computing device to use the particular server platform based on the unused state, wherein control of at least a portion of hardware of the particular server platform is temporarily granted to the edge computing device and control by the orchestrator is disabled in the BMAI session; and
end the BMAI session to restore control of the portion of the hardware of the particular server platform to the orchestrator.

18. The system of claim 17, wherein the edge computing device comprises an edge orchestrator to orchestrate a workload in an edge computing environment, wherein the edge orchestrator is to:
determine that additional hardware resources are to be used to execute the workload;
generate the request for the BMAI session to access the additional hardware resources for use in execution of the workload; and
control the portion of the hardware of the particular service platform during the BMAI session in connection execution of the workload.

19. The system of claim 17, wherein the request for the BMAI session comprises requested characteristics of hardware from the cloud computing system, and the particular server platform is selected for use in the BMAI session based on the requested characteristics.

20. The system of claim 19, wherein the requested characteristics comprises at least one of a listing of required hardware elements, a listing of required capabilities, or a geographic location for the hardware.
